(19) United States
(12) Patent Application Publication
(10) Pub. No.: US 2016/0039671 A1
(43) Pub. Date: Feb. 11, 2016

(54) OZONE GENERATOR

(71) Applicant: NGK INSULATORS, LTD., Nagoya-City (JP)

(72) Inventors: Tatsuya TERAZAWA, Kasugai-City (JP); Shoji YOKOI, Nagoya-City (JP); Naoya TAKASE, Konan-City (JP)

(21) Appl. No.: 14/818,442

(22) Filed: Aug. 5, 2015

(30) Foreign Application Priority Data
Aug. 8, 2014 (JP) 2014-162063

(51) Int. Cl. C01B 13/11

(52) U.S. Cl. CPC C01B 13/115; C01B 2201/10

(57) ABSTRACT

An ozone generator includes a transformer, a direct current power supply unit connected to a primary side of the transformer, a reactor connected to a secondary side of the transformer, a semiconductor switch connected between at least one end of a primary winding of the transformer and the direct current power supply unit, and a control circuit for implementing ON-OFF control of the semiconductor switch to thereby apply alternating current voltage to the reactor. The control circuit implements control of a frequency of the alternating current voltage applied to the reactor, so as to minimize electric signal on the primary side of the transformer.

### CROSS-REFERENCE TO RELATED APPLICATION

This application is based upon and claims the benefit of priority from Japanese Patent Application No. 2014-162063 filed on Aug. 8, 2014, the contents of which are incorporated herein by reference.

### BACKGROUND OF THE INVENTION

1. Field of the Invention

The present invention relates to an ozone generator. More specifically, the present invention relates to an ozone generator, e.g., suitable for in-vehicle applications.

2. Description of the Related Art

In general, in a discharge cell for ozone generation, it is widely known that when high voltage is applied by resonance operation, ozone is generated highly efficiently. In this case, it is suitable to utilize the resonance frequency of a resonance unit made up of the parasitic capacitance component of the discharge cell and an inductor connected in series with the discharge cell for driving an inverter at the resonance frequency to apply high voltage. A discharge cell discharging circuit described in Japanese Patent No. 5193086 is an example of an ozone generator for realizing this technique.

This discharge cell discharging circuit is a circuit made up of a pair of flat plates and a dielectric body for generating high concentration ozone. This discharge cell discharging circuit allows adjustment of the amount of ozone generation while automatically keeping the drive frequency of frequency applying means at a frequency near the resonance frequency at all times.

Specifically, the discharge cell discharging circuit has a tuning control unit for controlling the drive frequency of the inverter such that the resonance frequency of the resonance unit is tuned to the drive frequency of the inverter.

This tuning control unit implements feedback control of the inverter such that the drive frequency of the inverter is tuned to the resonance frequency of the resonance unit, based on the resonance phase difference signal indicating difference between the phase of the current flowing through the resonance unit on the secondary side of the transformer and the phase of the voltage of the resonance unit.

### SUMMARY OF THE INVENTION

The ozone generator is, e.g., mounted in a vehicle. In the ozone generator for use of in-vehicle applications, for example, ozone generated by the ozone generator is mixed into injected fuel in synchronization with the injection of fuel into a combustion chamber, to thereby facilitate ignition of the fuel.

According to the description of Japanese Patent No. 5193086, the tuning control unit of the discharge cell discharging circuit implements control by detecting the difference between the phase of the current flowing through the resonance unit on the secondary side of the transformer and the phase of the voltage of the resonance unit. Since voltage generated on the secondary side of the transformer has a high voltage value boosted by the transformer, a large-scale circuit configuration for high voltage is required as the tuning control unit. Thus, if the discharge cell discharging circuit according to Japanese Patent No 5193086 is applied to an ozone generator, the ozone generator is increased in size and also in cost, and it is difficult to apply the discharge cell discharging circuit to an in-vehicle ozone generator.

There is another approach in which the resonance frequency on the secondary side is stored beforehand and the inverter is operated at the stored resonance frequency. However, the resonance frequency varies with changing atmosphere under which ozone is generated (e.g., temperature, humidity, pressure, electrode contamination, etc.), and consequently loss of circuit is increased disadvantageously.

The present invention has been made taking such a problem into account, and an object of the present invention is to provide an ozone generator, which makes it possible to reduce size and cost and also be installed in a vehicle, etc., and which is capable of easily generating ozone with high efficiency and maintaining high-efficient ozone generation at all times.

[1 ] An ozone generator according to the present invention includes a transformer, a direct current power supply unit connected to a primary side of the transformer, a reactor connected to a secondary side of the transformer, a switching unit connected between at least one end of a primary winding of the transformer and the direct current power supply unit, and a control circuit configured to implement ON-OFF control of the switching unit to thereby apply voltage to the reactor. The control circuit implements control of a frequency of the voltage applied to the reactor so as to minimize electric signal on the primary side of the transformer.

Thus, it is possible to easily tune the switching frequency for turning on and off the switching unit to the resonance frequency on the secondary side of the transformer. Therefore, improvement in the efficiency of ozone generation can be easily realized, and the high efficiency in ozone generation can be maintained all the time. Further, since it is not required for the control circuit to refer to the high voltage, etc. on the secondary side, the circuit structure is simple, and size reduction can be achieved.

Accordingly, for example, the ozone generator according to the present invention can be suitably used for the ozone generator mounted in a vehicle. In an application of the in-vehicle ozone generator, for example, ozone generated by the ozone generator is mixed into injection fuel in accordance with the timing of fuel injection into a combustion chamber to thereby facilitate ignition of the fuel.

[2] In the present invention, the control circuit may implement control to minimize the electric signal on the primary side of the transformer by updating a switching frequency used for ON-OFF control of the switching unit, from a reference frequency by a fixed change width.

In this case, it is not necessary to store beforehand the resonance frequency on the secondary side. Further, even if the resonance frequency varies depending on an atmosphere under which ozone is generated (temperature, humidity, pressure, electrode contamination, etc.), it is possible to tune the switching frequency for turning on and off the switching unit, to the changed resonance frequency.

[3] In the present invention, the switching unit may be connected between the one end of the primary winding of the transformer and the direct current power supply unit.
[4] In this case, the control circuit may implement control of the frequency of the voltage applied to the reactor so as to minimize the current value on the primary side of the transformer.

In this manner, since it is sufficient to only detect the current value on the primary side, the circuit structure of the ozone generation is simple, and it becomes possible to easily tune the switching frequency for turning on and off the switching unit to the resonance frequency on the secondary side of the transformer.

[5] Alternatively, the control circuit may implement control of the frequency of the voltage applied to the reactor so as to minimize the power value on the primary side of the transformer.

In this control, by referring to the power value obtained from the voltage value and the current value on the primary side, even in the case where the power supply voltage of the direct current power supply unit varies, it is possible to easily tune the switching frequency for turning on and off the switching unit to the resonance frequency on the secondary side of the transformer.

[6] In the present invention, the switching unit may be connected between both ends of the transformer and both ends of the direct current power supply unit.
[7] In this case, the control circuit may implement control of the frequency of the voltage applied to the reactor so as to cause the phase difference between current and voltage on the primary side of the transformer to become zero.

In this control, since the phase difference between the current and the voltage on the primary side of the transformer is referred to, the ozone generator can be suitably used as an ozone generator having an inverter connected between the transformer and the direct current power supply unit. It is possible to easily tune the switching frequency for turning on and off the inverter to the resonance frequency on the secondary side of the transformer.

[8] In the present invention, the reactor may include one or more electrode pairs each including two discharge electrodes spaced from each other by a predetermined gap length, and the reactor may generate ozone by allowing a source gas to pass through a space between at least the two discharge electrodes of the electrode pair and then causing electric discharge between the two discharge electrodes by the voltage applied between the two discharge electrodes.

According to the ozone generator of the present invention, it is possible to reduce size and cost and also be installed in a vehicle, etc. Further, it is possible to easily generate ozone with high efficiency and maintain the high-efficient ozone generation at all times.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a circuit diagram showing structure of an ozone generator (first ozone generator) according to a first embodiment;

FIG. 2 is a vertical cross sectional view enlargedly showing main components of a reactor;

FIG. 3 is a cross sectional view taken along a line in FIG. 2:

FIG. 4 is a timing chart showing operation of the first ozone generator;

FIG. 5 is a graph showing change of current value on the primary side with respect to the switching frequency in the first ozone generator;

FIG. 6 is a flow chart showing operation of the first ozone generator;

FIG. 7 is a circuit diagram showing structure of an ozone generator (second ozone generator) according to a second embodiment;

FIG. 8 is a graph showing change of power value on the primary side with respect to the switching frequency, in the second ozone generator;

FIG. 9 is a flow chart showing operation of the second ozone generator;

FIG. 10 is a circuit diagram showing structure of an ozone generator (third ozone generator) according to a third embodiment;

FIG. 11 is a graph showing change in the phase difference between the voltage and current on the primary side with respect to the switching frequency, in the third ozone generator; and

FIG. 12 is a flow chart showing operation of the third ozone generator.

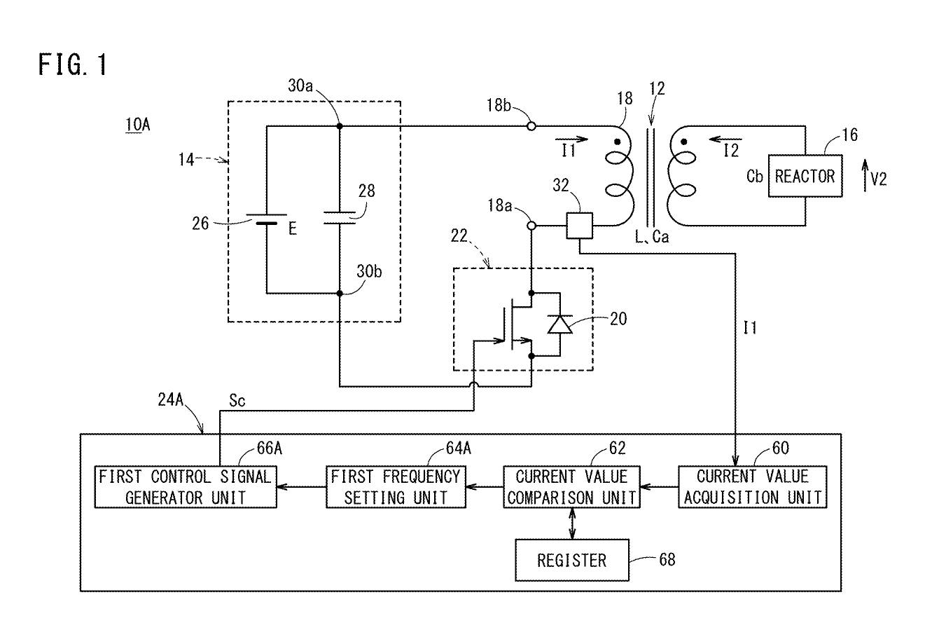

### DESCRIPTION OF THE PREFERRED EMBODIMENTS Hereinafter, preferred embodiments of ozone generators according to the present invention will be described with reference to FIGS. 1 to 12.

Firstly, as shown in FIG. 1, an ozone generator according to a first embodiment of the present invention (hereinafter referred to as a first ozone generator 10A) includes a transformer 12, a direct current power supply unit 14 connected to the primary side of the transformer 12, a reactor 16 connected to the secondary side of the transformer 12, a semiconductor switch (switching unit) 22 connected between one end 18a of a primary winding 18 of the transformer 12 and the direct current power supply unit 14, and having a diode 20 connected in reverse-parallel, and a first control circuit 24A for applying voltage to the reactor 16 by implementing ON-OFF control of the semiconductor switch 22.

The direct current power supply unit 14 is formed by connecting a direct current power supply 26 and a capacitor 28 in parallel. Therefore, a positive electrode terminal 30a of the direct current power supply unit 14 (node between a positive (+) terminal of the direct current power supply 26 and one electrode of the capacitor 28) and the other end 18b of the primary winding 18 are connected, and the semiconductor switch 22 is connected between a negative electrode terminal 30b of the direct current power supply unit 14 (node between a negative (−) terminal of the direct current power supply 26 and the other electrode of the capacitor 28) and the one end 18a of the primary winding 18. In the example of FIG. 1, the semiconductor switch 22 is provided on the part of the negative electrode terminal 30b of the direct current power supply unit 14. However, it is a matter of course that the same advantages can be obtained also in the case where the semiconductor switch 22 is provided on the part of the positive electrode terminal 30a.

As the semiconductor switch 22, a self-extinguishing device or a commutation extinguishing device may be used. In this embodiment, the semiconductor switch 22 uses a field effect transistor, e.g., a metal oxide semiconductor field effect transistor (MOSFET) having an internal diode 20 connected in reverse-parallel. The MOSFET may be a SiC-MOSFET using SiC (Silicon Carbide).

The first control circuit 24A generates a switching control signal (hereinafter referred to as the control signal Sc) for implementing ON-OFF control of the semiconductor switch 22. The control signal Sc from the first control circuit 24A is applied to the gate of the semiconductor switch 22. By the first control circuit 24A, ON-OFF control of the semiconductor switch 22 is implemented.

The first ozone generator 10A has current detection means 32 for detecting the current (current value II) flowing through the primary side of the transformer 12. Although any means capable of detecting the current (current value I1) flowing through the primary side of the transformer 12 can be used as the current detection means 32, preferably, a non-contact type direct current meter, e.g., comprising DCCT (direct current transformer) should be adopted.

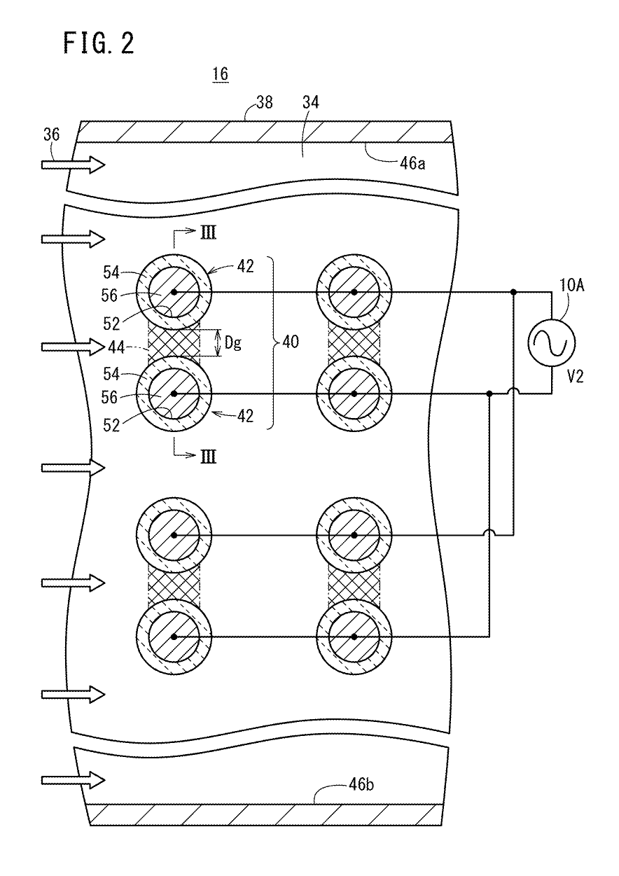

As shown in FIG. 2, the reactor 16 includes a casing 38 having a hollow portion 34 and at least one electrode pair 40 placed in the hollow portion 34 of the casing 38. A source gas 36 is supplied to the hollow portion 34. The electrode pair 40 comprises two discharge electrodes 42 spaced from each other by a predetermined gap length Dg.

The reactor 16 generates ozone by allowing the source gas 36 to pass through a space between at least two discharge electrodes 42 of the electrode pair 40 to thereby cause electric discharge between the two discharge electrodes 42. The space between two discharge electrodes 42 is a space where electric discharge occurs, and thus the space is defined as a discharge space 44.

In particular, in the embodiment of the present invention, a plurality of electrode pairs 40 are arranged in series or in parallel, or arranged in series and in parallel, between inner walls (one inner wall 46a and the other inner wall 46b) of the casing 38 that face each other. In the example of FIG. 2, the electrode pairs are arranged in series and in parallel.

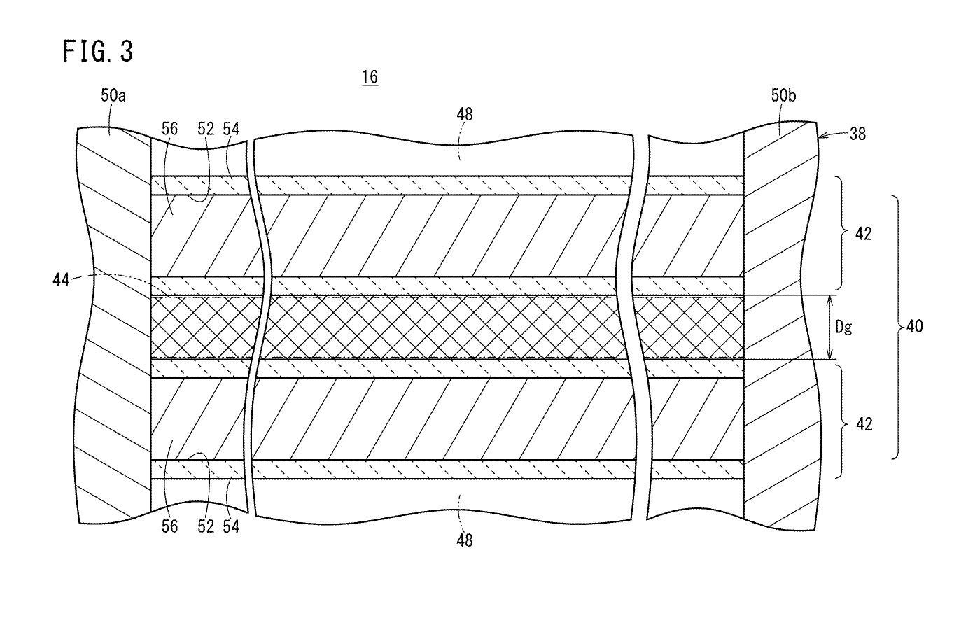

As shown in FIGS. 3, each of the discharge electrodes 42 has a rod shape, and extends along a source gas passing surface 48 having the normal direction in the main flow direction of the source gas 36 (see FIG. 2). Each of the discharge electrodes 42 extends between one side wall 50a and the other side wall 50b of the casing 38. That is, the discharge electrodes 42 extend across the hollow portion 34 of the casing 38 along the source gas passing surface 48, and are fixed to the one side wall 50a and the other side wall 50b of the casing 38. The main flow direction of the source gas 36 herein means a flow direction of the source gas 36 flowing at the central portion with directivity. This is intended to exclude directions of flow components without directivity in the marginal portions of the source gas 36.

Each of the discharge electrodes 42 includes a tubular dielectric body 54 having a hollow portion 52 and a conductor 56 positioned inside the hollow portion 52 of the dielectric body 54. In the example of FIGS. 2 and 3, the dielectric body 54 has a cylindrical shape, and the hollow portion 52 has a circular shape in transverse cross section. The conductor 56 has a circular shape in transverse cross section. It is a matter of course that the shapes of the dielectric body 54 and the conductor 56 are not limited to these shapes. The dielectric body 54 may have a polygonal cylindrical shape such as a triangle, quadrangle, pentagonal, hexagonal, or octagonal shape in transverse cross section. Correspondingly, the conductor 56 may have a polygonal columnar shape such as a triangle, quadrangle, pentagonal, hexagonal, or octagonal shape in transverse cross section.

The present embodiment is aimed at generation of ozone. Therefore, the source gas 36 may be a gas containing, for example, atmospheric air or oxygen. In this case, the gas may be air which has not been dehumidified.

Preferably, the conductor 56 is made of a material selected from a group consisting of molybdenum, tungsten, stainless steel, silver, copper, nickel, and alloy at least including one of these materials. As the alloy, for example, invar, kovar, Inconel (registered trademark), or Incoloy (registered trademark) may be used.

Further, preferably, the dielectric body 54 may be made of a ceramics material which can be fired at a temperature less than the melting point of the conductor 56. More specifically, the dielectric body 54 should preferably be made of single or complex oxide or complex nitride containing at least one material selected from a group consisting of, for example, barium oxide, bismuth oxide, titanium oxide, zinc oxide, neodymium oxide, titanium nitride, aluminum nitride, silicon nitride, alumina, silica, and mullite.

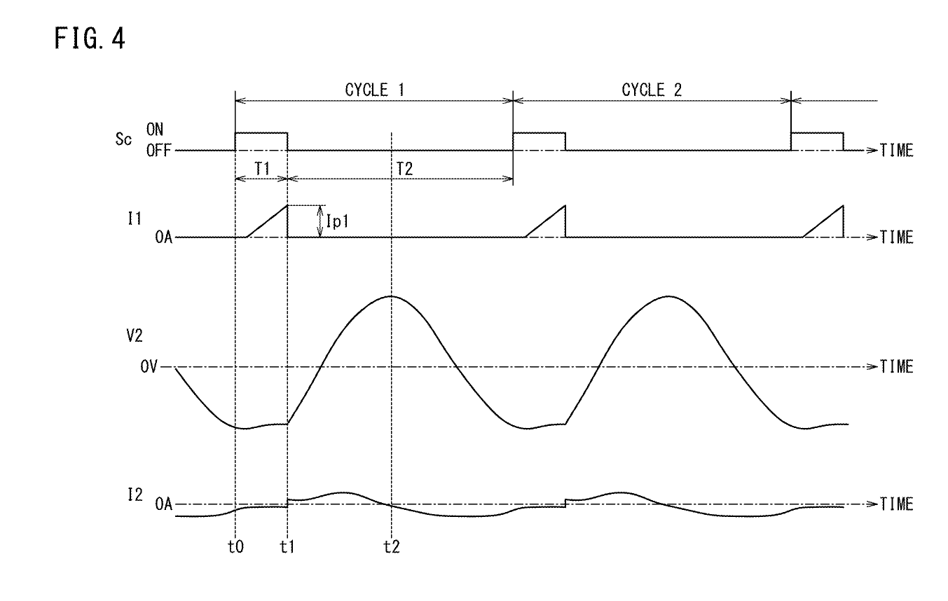

Next, operation of the first ozone generator 10A will be described with reference to FIG. 4.

Firstly, at the start point t0 of the cycle 1, when the semiconductor switch 22 is turned on, e.g., based on the input of the control signal Sc, voltage substantially equal to the power supply voltage E of the direct current power supply unit 14 is applied to the transformer 12 over the ON period T1 of the semiconductor switch 22. The primary current I1 flowing through the primary winding 18 of the transformer 12 increases linearly over time with a slope (E/L) where L denotes the primary inductance (excitation inductance) of the transformer 12. Induction energy is then accumulated in the transformer 12.

Thereafter, at the time point t1 where the primary current I1 reaches a predetermined peak value Ip1, when the semiconductor switch 22 is turned off, supply of alternating current high voltage V2 (secondary voltage) to the reactor 16 is started and the secondary current 12 flows in the positive direction. Then, at the time point t2 where the alternating current voltage V2 has a peak value, the secondary current 12 becomes zero. After the time point t2, the secondary current 12 flows in the negative direction.

The cycle 2 is started after the OFF period T2 of the semiconductor switch 22, and operation in the same manner as the above cycle 1 is repeated. Consequently, alternating current high voltage V2 is applied to the reactor 16.

Then, the first ozone generator 10A tunes the switching frequency f for turning on and off the semiconductor switch 22 to the secondary resonance frequency fc made up of the excitation inductance L and the winding capacitance Ca of the transformer 12, and the capacitance Cb between the discharge electrodes 42 of the reactor 16 to thereby achieve improvement in the efficiency of ozone generation.

In this regard, the first control circuit 24A controls the frequency of the alternating current voltage V2 applied to the reactor 16 such that the electrical signal on the primary side of the transformer 12 is minimized. In particular, in this first ozone generator IDA, the frequency of the alternating current voltage V2 applied to the reactor 16 is controlled such that the direct-current (DC) component of the current value I1 on the primary side of the transformer 12 is minimized.

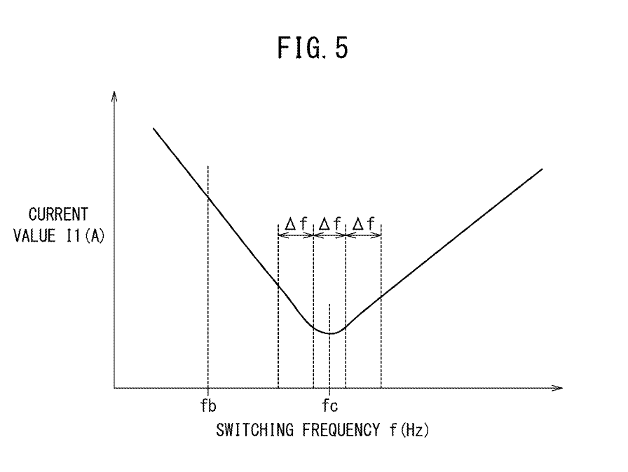

Specifically, as shown in FIG. 5, by successively changing the switching frequency f from a preset reference frequency fb in one direction (toward the higher frequency) in increments of a fixed change width Δf, the current value I1 (direct current component) on the primary side of the transformer 12 is decreased gradually. However, after the switching frequency f exceeds a certain frequency, the current value I1 is increased gradually. By setting the frequency f to a frequency corresponding to the minimum value of this current value I1, it becomes possible to tune the switching frequency f to the resonance frequency fc on the secondary side. It should be noted that, preferably, the reference frequency fb is lower than the resonance frequency fc as shown in FIG. 5.

Next, structure and operation of the first control circuit 24A of the first ozone generator 10A will be described with reference to FIGS. 1, 4, and 5.

Firstly, as shown in FIG. 1, the first control circuit 24A includes a current value acquisition unit 60 for acquiring the current value 11 from current detection means 32, a current value comparison unit 62 for comparing the previously acquired current value 11 with the presently acquired current value I1, a first frequency setting unit 64A for setting the switching frequency f to turn on and off the semiconductor switch 22 in correspondence with transition of the current value I1, and a first control signal generator unit 66A for generating and outputting a control signal So in correspondence with the set switching frequency f.

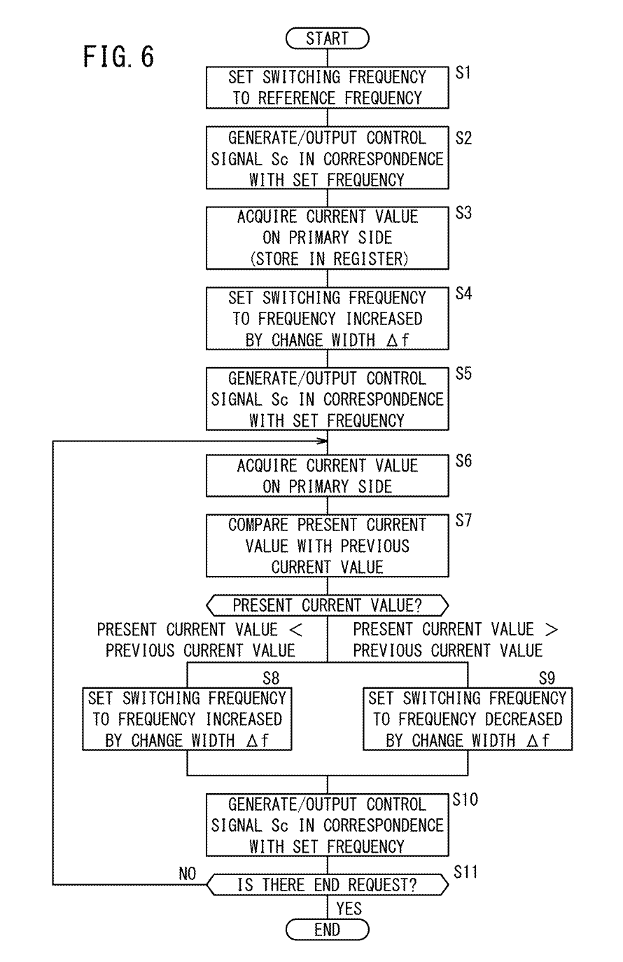

In step S1 of FIG. 6, the first frequency setting unit 64A sets the switching frequency f to the preset reference frequency fb.

In step S2, the first control signal generator unit 66A generates and outputs the control signal Sc in correspondence with the set switching frequency f.

In step S3, the current value acquisition unit 60 acquires the current value I1 from the current detection means 32, and stores the current value I1 in a register 68.

In step S4, the first frequency setting unit 64A sets the switching frequency f to a frequency which is higher than the current frequency by a preset change width Δf.

In step S5, the first control signal generator unit 66A generates and outputs the control signal Sc in correspondence with the set frequency.

In step S6, the current value acquisition unit 60 acquires the current value I1 from the current detection means 32.

In step S7, the current value comparison unit 62 compares the acquired current value I1 (present current value) with the previous current value I1 stored in the register 68.

In the case where the present current value 11 is lower than the previous current value 11, the routine proceeds to step S8, and the first frequency setting unit 64A sets the switching frequency f to a frequency which is higher than the present frequency by the preset change width Δf.

If the present current value II is higher than the previous current value I1, the routine proceeds to step 89, and the first frequency setting unit 64A sets the switching frequency f to a frequency which is lower than the present frequency by the preset change width Δf.

When the process in step S8 or the process in step S9 is finished, the routine proceeds to the next step S10, and the first control signal generator unit 66A generates and outputs the control signal Sc in correspondence with the set switching frequency f.

In the next step S11, it is determined whether or not there is a request for stopping operation of the first ozone generator 10A (a request for power-off, a request for a maintenance, etc.). If there is no request for stopping operation, the routine returns to step S6 to repeat the processes of step S6 and the subsequent steps. If there is a request for stopping operation, the process of the first ozone generator 10A is finished.

As described above, the first ozone generator 10A controls the frequency of the alternating current voltage V2 applied to the reactor 16 such that the current value I1 on the primary side of the transformer 12 is minimized. Thus, it is possible to easily tune the switching frequency f for turning on and off the semiconductor switch 22 to the resonance frequency fc on the secondary side of the transformer 12. Therefore, improvement in the efficiency of ozone generation can be easily realized, and the high efficiency in ozone generation can be maintained all the time. Further, since it is not required for the first control circuit 24A to refer to the high voltage, etc. on the secondary side, the circuit structure is simple, and size reduction can be achieved. Further, since it is sufficient to only detect the current value I1 on the primary side, the circuit structure of the first ozone generator 10A is simple, and it becomes possible to easily tune the switching frequency f for turning on and off the semiconductor switch 22 to the resonance frequency fc on the secondary side of the transformer 12.

Accordingly, for example, the first ozone generator 10A can be suitably used for the ozone generator mounted in a vehicle. In an application of the in-vehicle ozone generator, for example, ozone generated by the ozone generator is mixed into injection fuel in accordance with the timing of fuel injection into a combustion chamber to thereby facilitate ignition of the fuel.

The first control circuit 24A implements control to minimize the current value I1 on the primary side by updating the switching frequency f from the reference frequency fb by the fixed change width Δf. Thus, it is not necessary to store in advance the resonance frequency fc on the secondary side. Further, even if the resonance frequency fc varies depending on an atmosphere under which ozone is generated (temperature, humidity, pressure, electrode contamination, etc.), it is possible to tune the switching frequency f to the changed resonance frequency fc.

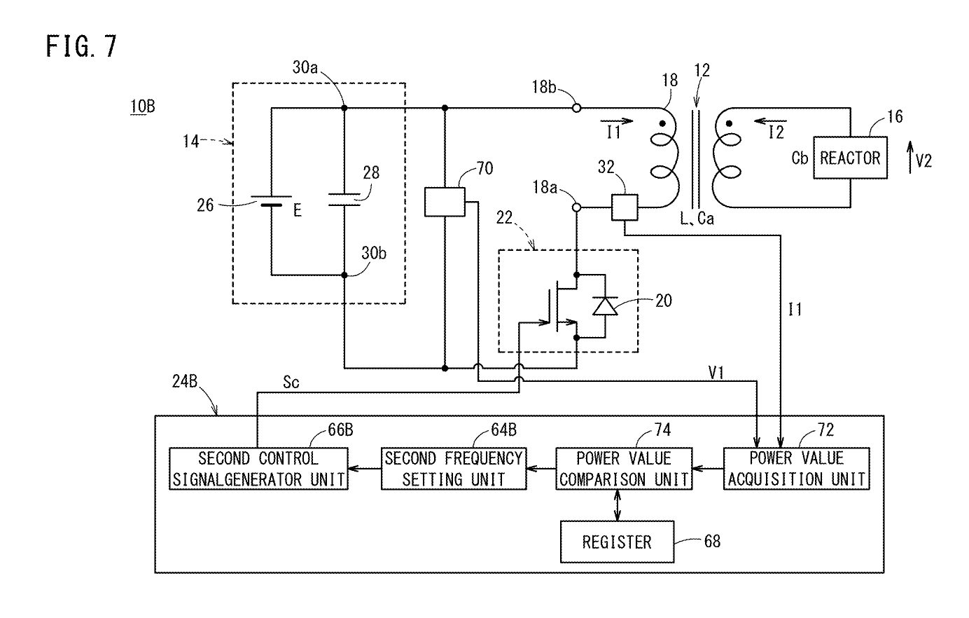

Next, an ozone generator according to a second embodiment of the present invention (hereinafter referred to as a second ozone generator 10B) will be described with reference to FIGS. 7 to 9.

As shown in FIG. 7, the second ozone generator 10B has substantially the same structure as the above described first ozone generator 10A. However, the second ozone generator 10B is different from the first ozone generator 10A in that the second ozone generator 10B has a control circuit (second control circuit 24B) which controls the frequency of the alternating current voltage V2 applied to the reactor 16 such that the power value P1 on the primary side of the transformer is minimized.

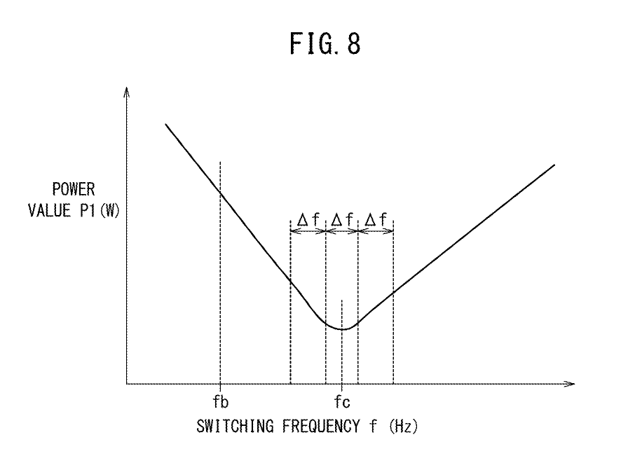

As shown in FIG. 8, by successively changing the switching frequency f by the fixed change width Δf in one direction from the preset reference frequency fb, the power value P1 on the primary side of the transformer 12 is decreased gradually. However, when the switching frequency f exceeds a certain frequency, the power value P1 on the primary side of the transformer 12 is increased gradually. By setting the switching frequency f to a frequency corresponding to the minimum value of this power value P1, it becomes possible to tune the switching frequency f to the resonance frequency fc on the secondary side.

Thus, as shown in FIG. 7, the second ozone generator 10B includes voltage detection means 70 for detecting the direct current voltage (voltage value V1) on the primary side, a power value acquisition unit 72 for multiplying the voltage value V1 from the voltage detection means 70 by the current value I1 from the current detection means 32 to thereby determine the power value P1, a power value comparison unit 74 for comparing the previously acquired power value with the presently acquired power value, a second frequency setting unit 64B for setting the switching frequency f for turning on and off the semiconductor switch 22 in correspondence with transition of the power value P1, and a second control signal generator unit 66B for generating and outputting the control signal Sc in correspondence with the set switching frequency f.

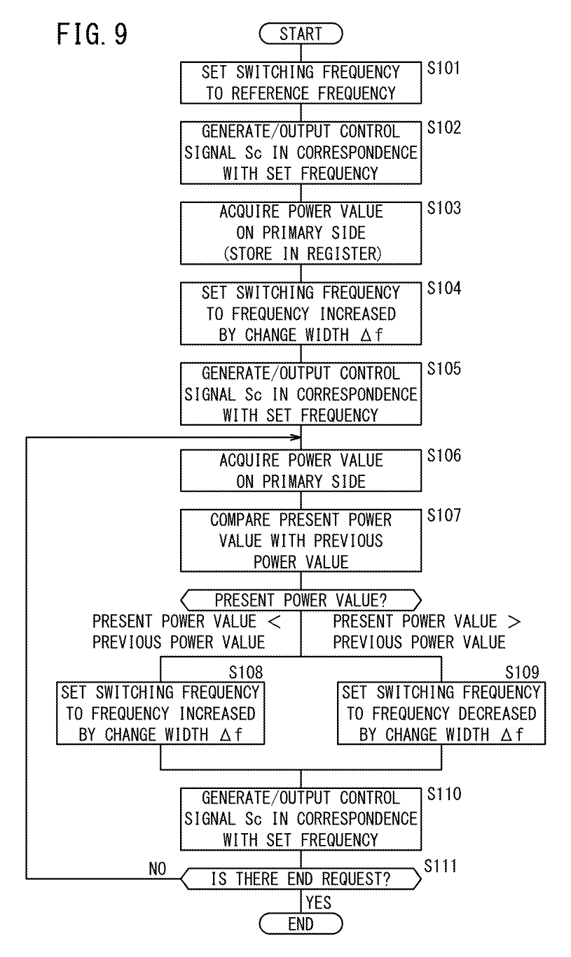

Next, operation of the second ozone generator 10B will be described with reference to FIG. 9.

In step S101 of FIG. 9, the second frequency setting unit 64B sets the switching frequency f to the preset reference frequency fb.

In step S102, the second control signal generator unit 66B generates and outputs the control signal Sc in correspondence with the set switching frequency f.

In step S103, the power value acquisition unit 72 determines the power value P1 by multiplying the voltage value V1 from the voltage detection means 70 by the current value I1 from the current detection means 32, and stores the acquired power value P1 in a register 68.

In step S104, the second frequency setting unit 64B sets the switching frequency f to a frequency which is higher than the present frequency by a preset change width. Δf.

In step S105, the second control signal generator unit 66B generates and outputs the control signal Sc in correspondence with the set frequency.

In step S106, the power value acquisition unit 72 multiplies the voltage value V1 from the voltage detection means 70 by the current value I1 from the current detection means 32 to thereby determine the power value P1.

In step S107, the power value comparison unit 74 compares the acquired power value P1 (present power value) with the previous power value P1 stored in the register 68.

If the present power value P1 is lower than the previous power value P1, the routine proceeds to step S108, and the second frequency setting unit 64B sets the switching frequency f to a frequency which is higher than the present frequency by the preset change width Δf.

If the present power value P1 is higher than the previous power value P1, the routine proceeds to step S109, and the second frequency setting unit 64B sets the switching frequency f to a frequency which is lower than the present frequency by the preset change width Δf.

After the process in step S108 or the process in step S109 is finished, the routine proceeds to the next step S110, and the second control signal generator unit 66B generates and outputs the control signal Sc in correspondence with the set switching frequency f.

In next step S111, it is determined whether or not there is a request for the second ozone generator 108 to stop operation (a request for power-off, a request for a maintenance, etc.). If there is no request to stop operation, the routine returns to step S106 to repeat the processes in step S106 and the subsequent steps. If there is a request to stop operation, the process of the second ozone generator 108 is finished.

As described above, the second ozone generator 108 controls the frequency of the alternating current voltage V2 applied to the reactor 16 such that the power value P1 on the primary side of the transformer 12 is minimized. Thus, it is possible to easily tune the switching frequency f for turning on and off the semiconductor switch 22 to the resonance frequency fc on the secondary side of the transformer 12. Therefore, improvement in the efficiency of the ozone generation can be realized, and the high efficiency can be maintained in ozone generation all the time. Further, since it is not required for the second control circuit 2413 to refer to the high voltage, etc. on the secondary side, the circuit structure is simple, and size reduction can be achieved. In the structure, as in the case of the first ozone generator 10A, the second ozone generator 10B can be used suitably, e.g., as an in-vehicle ozone generator. Further, control is performed to minimize the power value P1 on the primary side while updating the switching frequency f from the reference frequency fb by the fixed change width Δf. Thus, it is not necessary to store in advance the resonance frequency fc on the secondary side.

Further, even if the resonance frequency fc varies depending on an atmosphere under which ozone is generated, it is possible to tune the switching frequency f to the changed resonance frequency fc.

In particular, since the second ozone generator 10B refers to the power value P1 based on the voltage value V1 and the current value I1 on the primary side, even in the case where the power supply voltage of the direct current power supply unit 14 varies, it is possible to easily tune the switching frequency £ for turning on and off the semiconductor switch 22 to the resonance frequency fc on the secondary side of the transformer 12.

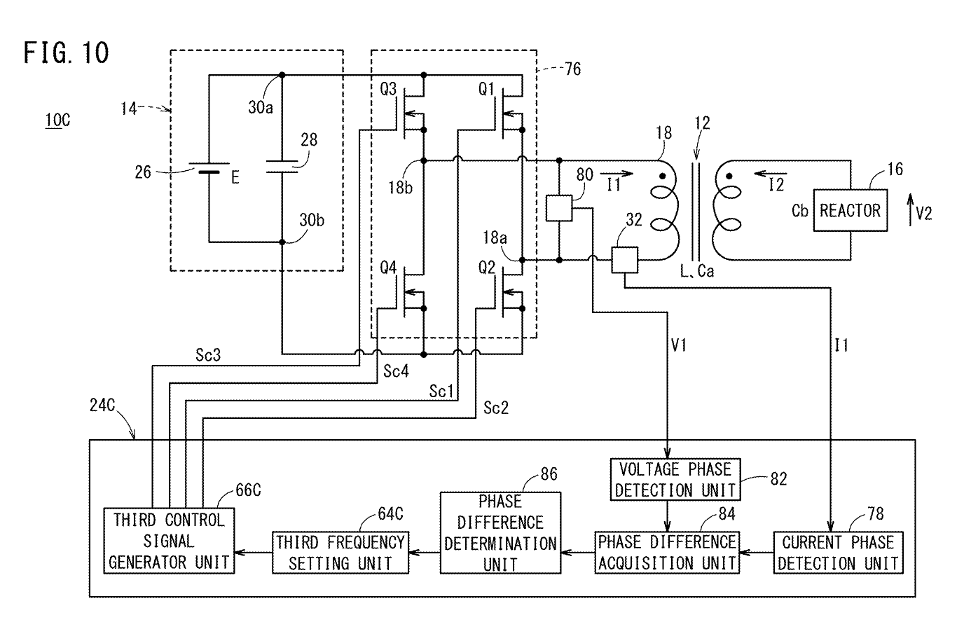

Next, an ozone generator according to a third embodiment of the present invention (hereinafter referred to as a third ozone generator 10C) will be described with reference to FIGS. 10 to 12.

As shown in FIG. 10, the third ozone generator 10C has substantially the same structure as the above described first ozone generator 10A. However, the third ozone generator 10C is different from the first ozone generator 10A in that an inverter 76 is connected between the direct current power supply unit 14 and the transformer 12.

The inverter 76 includes a first semiconductor switch Q1 connected between the positive electrode terminal 30a of the direct current power supply unit 14 and one end 18a of the primary winding 18 of the transformer 12, a second semiconductor switch Q2 connected between the one end 18a of the primary winding 18 and a negative electrode terminal 30b of the direct current power supply unit 14, a third semiconductor switch Q3 connected between a positive electrode terminal 30a of the direct current power supply unit 14 and the other end 18b of the primary winding 18, and a fourth semiconductor switch Q4 connected between the other end 18b of the primary winding 18 and the negative electrode terminal 30b of the direct current power supply unit 14.

A third control circuit 24C of the third ozone generator 10C generates a first control signal Sc1 to a fourth control signal Sc4 for implementing ON-OFF control of the first semiconductor switch Q1 to the fourth semiconductor switch Q4, respectively. For example, in the former half of each cycle, both of, e.g., the second semiconductor switch Q2 and the third semiconductor switch Q3 are turned on, and both of the first semiconductor switch Q1 and the fourth semiconductor switch Q4 are turned off. Consequently, the current (current value I1) on the primary side flows from the other end 18b to the one end 18a of the primary winding 18. In the latter half of each cycle, both of the semiconductor switch Q1 and the fourth semiconductor switch Q4 are turned on, and both of the second semiconductor switch Q2 and the third semiconductor switch Q3 are turned off. Consequently, the current (current value I1) on the primary side flows from the one end 18a to the other end 18b of the primary winding 18. Therefore, alternating current high voltage V2 is applied to the reactor 16.

Further, the third control circuit 24C implements control of the frequency of the alternating current voltage V2 applied to the reactor 16 such that the difference (phase difference θ) between the phase of the voltage (voltage value V1) on the primary side of the transformer 12 and the phase of the current (current value I1) on the primary side of the transformer 12 becomes zero.

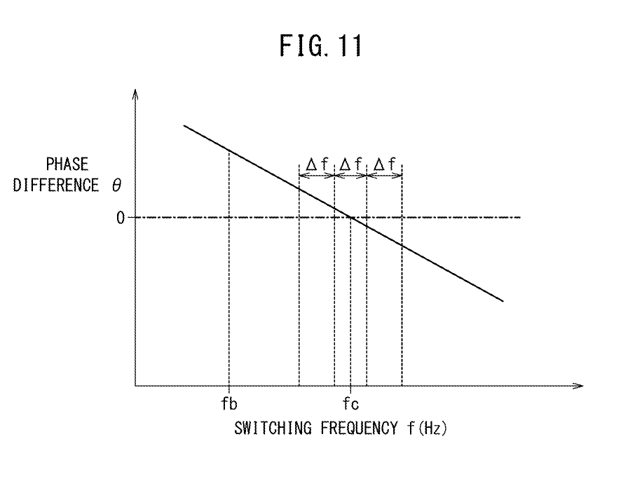

As shown in FIG. 11, when the switching frequency f is successively changed in one direction in increments of the fixed change width Δf, the phase difference θ is decreased gradually. By setting the switching frequency f to a frequency where the phase difference θ becomes zero, it becomes possible to tune the switching frequency f to the resonance frequency fc on the secondary side.

Thus, as shown in FIG. 10, the third ozone generator 10C includes a current phase detection unit 78 for detecting the phase of the current on the primary side from the current value I1 detected by the current detection means 32, primary voltage detection means 80 for detecting the primary voltage V1 between the one end 18a and the other end 18b of the primary winding 18, and a voltage phase detection unit 82 for detecting the phase of the voltage on the primary side from the voltage value VI detected by the primary voltage detection means 80.

Further, the third ozone generator 10C has a phase difference acquisition unit 84 for calculating the difference (phase difference θ) between the voltage phase from the voltage phase detection unit 82 and the current phase from the current phase detection unit 78, a phase difference determination unit 86 for determining whether the phase difference θ has a positive value or a negative value, a third frequency setting unit 64C for setting the switching frequency f for turning on and off the first semiconductor switch Q1 to the fourth semiconductor switch Q4, in correspondence with transition of the phase difference θ, and a third control signal generator unit 66C for generating and outputting the first control signal Sc1 to the fourth control signal Sc4 in correspondence with the set switching frequency f.

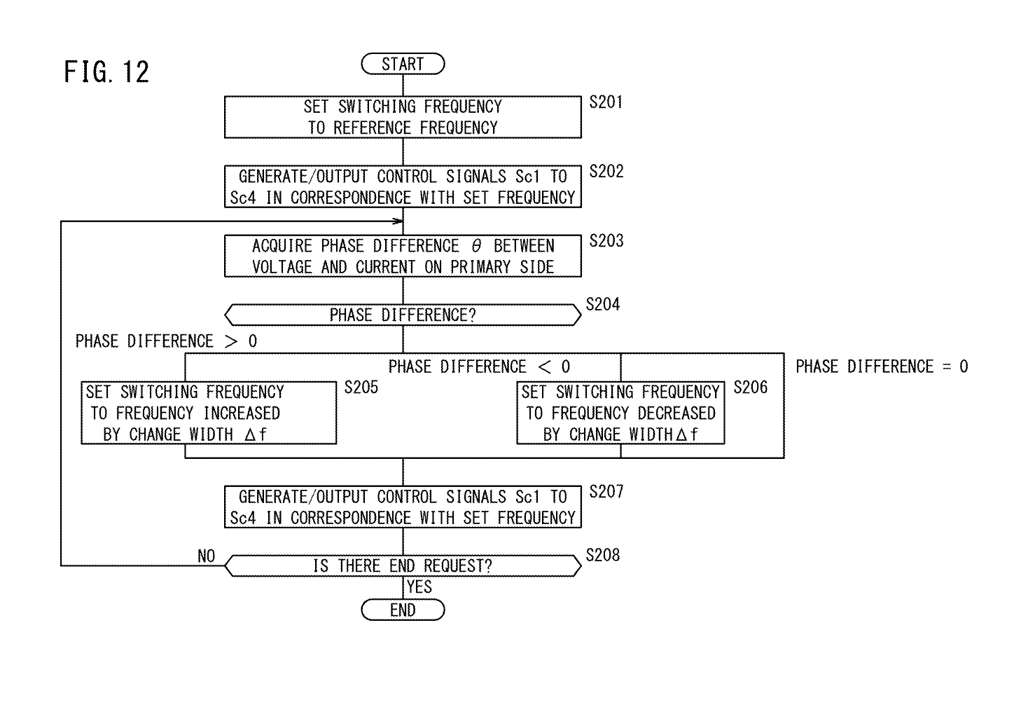

Next, operation of the third ozone generator 10C will be described with reference to FIG. 12.

In step S201 of FIG. 12, the third frequency setting unit 64C sets the switching frequency f to the preset reference frequency fb.

In step S202, the third control signal generator unit 66C generates and outputs the first control signal Sc1 to the fourth control signal Sc4 in correspondence with the set switching frequency f.

In step S203, the phase difference acquisition unit 84 acquires the difference (phase difference θ) between the voltage phase from the voltage phase detection unit 82 and the current phase from the current phase detection unit 78.

In step S204, the phase difference determination unit 86 determines whether the phase difference θ has a positive value or a negative value.

If the phase difference θ has a positive value, the routine proceeds to step S205, and the third frequency setting unit 64C sets the switching frequency f to a frequency which is higher than the present frequency by a preset change width Δf.

If the phase difference θ has a negative value, the routine proceeds to step S206, and the third frequency setting unit 64C sets the switching frequency f to a frequency which is lower than the present frequency by the preset change width Δf.

If the phase difference θ is zero, the third frequency setting unit 64C maintains the switching frequency f at the present frequency.

When the process in step S205 or the process in step S206 is finished, or if the phase difference θ is zero, the routine proceeds to the next step S207, and the third control signal generator unit 66C generates and outputs the first control signal Sc1 to the fourth control signal Sc4 in correspondence with the set frequency.

In the next step S208, it is determined whether or not there is a request for the third ozone generator IOC to stop operation (a request for power-off, a request for maintenance, etc.). If there is no request to stop operation, the routine returns to step S203 to repeat the processes in step S203 and the subsequent steps. If there is a request to stop operation, the process of the third ozone generator IOC is finished.

As described above, the third ozone generator 10C controls the frequency of the alternating current voltage V2 applied to the reactor 16 such that the phase difference θ between the current on the primary side of the transformer 12 and the voltage on the primary side of the transformer 12 becomes zero. Thus, it is possible to easily tune the switching frequency f for turning on and off the inverter 76 to the resonance frequency fc on the secondary side of the transformer 12. Therefore, improvement in the efficiency of the ozone generation can be easily realized, and the high efficiency in ozone generation can be maintained all the time. Further, since it is not required for the third control circuit 24C to refer to the high voltage, etc. on the secondary side, the circuit structure is simple, and size reduction can be achieved. In the structure, as in the case of the first ozone generator 10A, the third ozone generator 10C can be used suitably, e.g., as an in-vehicle ozone generator. Further, control is performed such that the phase difference θ between the current and the voltage on the primary side becomes zero, while updating the switching frequency f from the reference frequency fb by the fixed change width Δf. Thus, it is not necessary to store in advance the resonance frequency fc on the secondary side. Further, even if the resonance frequency fc varies depending on an atmosphere under which ozone is generated, it is possible to tune the switching frequency f to the changed resonance frequency fc.

In particular, since the third ozone generator 10C refers to the phase difference 0 between the current and the voltage on the primary side of the transformer 12, the third ozone generator 10C is suitably used as an ozone generator having the inverter 76 connected between the transformer 12 and the direct current power supply unit 14. It is possible to easily tune the switching frequency f for turning on and off the inverter 76 to the resonance frequency fc on the secondary side of the transformer 12.

It is a matter of course that the ozone generator is not limited to the embodiments described above, and various structures can be adopted without departing from the scope of the invention as defined by the appended claims.

What is claimed is:

1. An ozone generator comprising:
a transformer;
a direct current power supply unit connected to a primary side of the transformer;
a reactor connected to a secondary side of the transformer;
a switching unit connected between at least one end of a primary winding of the transformer and the direct current power supply unit; and
a control circuit configured to implement ON-OFF control of the switching unit to thereby apply voltage to the reactor,
wherein the control circuit implements control of a frequency of the voltage applied to the reactor so as to minimize electric signal on the primary side of the transformer.

2. The ozone generator according to claim 1, wherein the control circuit implements control to minimize the electric signal on the primary side of the transformer by updating a switching frequency used for ON-OFF control of the switching unit, from a reference frequency by a fixed change width.

3. The ozone generator according to claim 1, wherein the switching unit is connected between the one end of the primary winding of the transformer and the direct current power supply unit.

4. The ozone generator according to claim 3, wherein the control circuit implements control of the frequency of the voltage applied to the reactor so as to minimize a current value on the primary side of the transformer.

5. The ozone generator according to claim 3, wherein the control circuit implements control of the frequency of the voltage applied to the reactor so as to minimize a power value on the primary side of the transformer.

6. The ozone generator according to claim 1, wherein the switching unit is connected between both ends of the transformer and both ends of the direct current power supply unit.

7. The ozone generator according to claim 6, wherein the control circuit implements control of the frequency of the voltage applied to the reactor so as to cause phase difference between current and voltage on the primary side of the transformer to become zero.

8. The ozone generator according to claim 1, wherein the reactor includes one or more electrode pairs each comprising two discharge electrodes spaced from each other by a predetermined gap length; and
the reactor generates ozone by allowing a source gas to pass through a space between at least the two discharge electrodes of the electrode pair and then causing electric discharge between the two discharge electrodes by the voltage applied between the two discharge electrodes.
